(19) United States
(12) Patent Application Publication
(10) Pub. No.: US 2011/0302789 A1
(43) Pub. Date: Dec. 15, 2011

(54) Hair Trimmer

(76) Inventors: Chin-Chuan CHEN, Hsin-Chuang City (TW); Yu-Hsia Chen Yang, Hsin-Chuang City (TW); Hung-Chieh Chen, Hsin-Chuang City (TW); Cheng-I Chen, Hsin-Chuang City (TW); Cheng-Hsiang Chen, Hsin-Chuang City (TW)

(21) Appl. No.: 12/276,346

(22) Filed: Nov. 23, 2008

(30) Foreign Application Priority Data
Aug. 26, 2008 (TW) 097215323

(51) Int. Cl. B26B 13/24

(52) U.S. Cl. 30/233.5

(57) ABSTRACT

A hair trimmer includes a fixture having an upper and a lower tie plates, with an elastic element between the upper and lower tie plates; at least two cutting units at an end of the upper and lower tie plates, with each cutting unit having a corresponding cutting part, and an end of each cutting part having notches of different depths; and at least two combing units assembled with the upper and lower tie plates and corresponding to an exterior side of each cutting unit, with each combing unit including a teeth part which corresponds to each other and is parallel to the cutting part, and an end of each teeth part having comb slots of different depths. Therefore, a multiedged thinning can be carried out while trimming and it allows the hair to have more different levels of edge and a sense of beauty.

### BACKGROUND OF THE INVENTION

a) Field of the Invention

The present invention relates to a hair trimmer, and more particularly to a hair trimmer which utilizes a combination of fixture, cutting unit and combing unit to carry out a thinning operation when trimming, enabling the hair to be trimmed with different levels of edge and a sense of style and beauty.

b) Description of the Prior Art

An ordinary and conventional hair trimmer is usually constituted by a fixture and a blade part which is provided respectively at an end of the fixture, whereas the fixture includes at least two tie plates and the blade part is vertically and correspondingly provided at an end of the tie plate, respectively. Thus, the fixture can be transfixed correspondingly at a pre-determined position of hair to be trimmed, such that the hair can be located at an edge of the blade part. After that, external force is directly applied to the tie plates of fixture, forcing the tie plates to be abutted by the external force, thereby enabling the blade part to conduct the hair trimming operation.

Although the aforementioned conventional hair trimmer can use the blade part to conduct the hair trimming, the hair trimmer utilizes the monotonous blade part to cut off the hair directly, which is in lack of a hair cutting efficiency and is unable to control a cutting position, length and thickness of level of the hair. Therefore, after trimming, the hair does not have a change of level, enabling a tail end of the hair to be too monotonous to be in short of beauty. Accordingly, the conventional hair trimmer is unable to meet a practical need, relatively.

### SUMMARY OF THE INVENTION

The primary object of present invention is to provide a hair trimmer which utilizes a combination of fixture, cutting unit and combing unit to conduct a multi-edged thinning operation when trimming, so as to achieve an effect of having a sense of level and beauty after trimming the hair.

Accordingly, the present invention is a hair trimmer which includes a fixture having an upper and a lower tie plates, with an end of the upper and lower tie plates being pivoted together and an elastic element being provided between the upper and lower tie plates; at least two cutting units vertically provided at an end of the upper and lower tie plates respectively, with each cutting unit being provided with a corresponding cutting part, and an end of each cutting part being provided with a plurality of notches of different depth; and at least two combing units being assembled with the upper and lower tie plates and corresponding to an exterior side of each cutting unit, with each combing unit including respectively a teeth part which corresponds to each other and is parallel to the cutting part, and an end of each teeth part also being provided with a plurality of comb slots of different depth. When trimming hair, the hair falls into the comb slots and notches of different depths randomly, enabling the hair to have cutting points of multiple variations, so as to improve a hair trimming efficiency, carry out a function of multi-edged thinning and a beautiful sense of level after trimming.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a first embodiment of the present invention.

FIG. 2 shows an exploded view of a first embodiment of the present invention.

FIG. 3 shows a cutaway view of a first embodiment of the present invention.

FIG. 4 shows a schematic view of a state of application of a first embodiment of the present invention.

FIG. 5 shows another schematic view of a state of application of a first embodiment of the present invention.

FIG. 6 shows a front view of a combing unit of an embodiment of he present invention.

FIG. 7 shows a front view of a cutting unit of an embodiment of the present invention.

FIG. 8 shows a three-dimensional view of a second embodiment of the present invention.

FIG. 9 shows a schematic view of a complete trimming of a second embodiment of the present invention.

FIG. 10 shows a schematic view of a partial trimming of a second embodiment of the present invention.

### DETAILED DESCRIPTION OF THE PREFERRED EMBODIMENTS

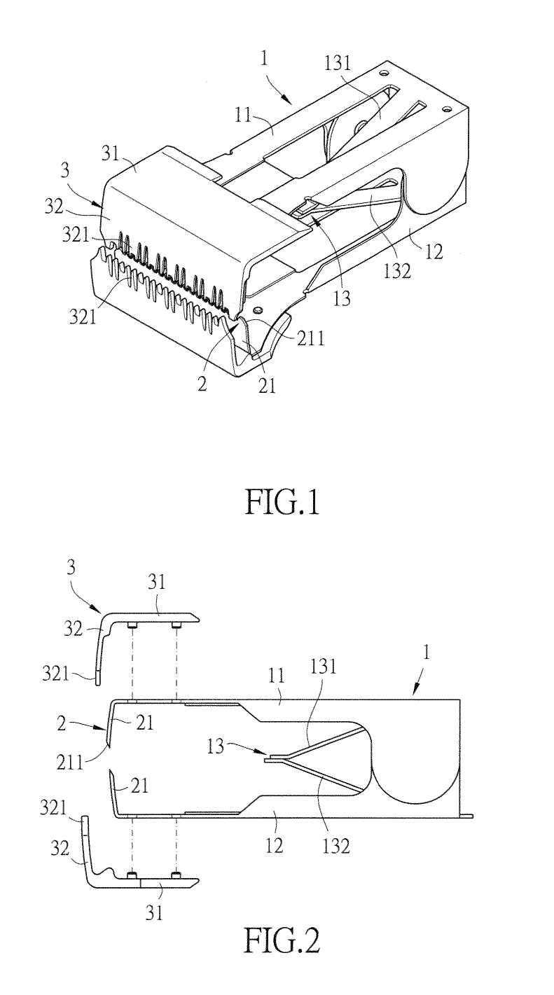

Referring to FIGS. 1 to 3, it shows a three-dimensional view, an exploded view and a cutaway view of a first embodiment of the present invention. A hair trimmer comprises at least a fixture 1, at least two cutting units 2 and at least two combing units 3.

The aforementioned fixture 1 includes at least an upper and a lower tie plates 11, 12, one end of which is pivoted together. An elastic element 13 is provided between the upper and lower tie plates 11, 12, and can be configured as spring leaves 131, 132 which are provided respectively at an inner surface of the upper and lower tie plates 11, 12 and are abutted with each other.

Each cutting unit 2 is assembled respectively at an end of the upper and lower tie plates 11, 12 and is provided respectively with a corresponding cutting part 21; whereas, an end of each cutting part 21 can be provided respectively with a plurality of notches 211 of different depth.

Each combing unit 3 is assembled respectively with the upper and lower tie plates 11, 12 and corresponds to an exterior side of each cutting unit 2. Each combing unit 3 is transversely provided with a fixing plate 31 respectively, and each fixing plate 31 is fixed respectively at an exterior surface of the upper and lower tie plates 11, 12. In addition, an end of each fixing plate 31 is bended downward to extend with a teeth part 32 which corresponds to each other and is parallel to the cutting part 21, and an end of each teeth part 32 is provided respectively with a plurality of comb slots 321 of different depth. Accordingly, a practical hair trimmer is formed by the aforementioned structures.

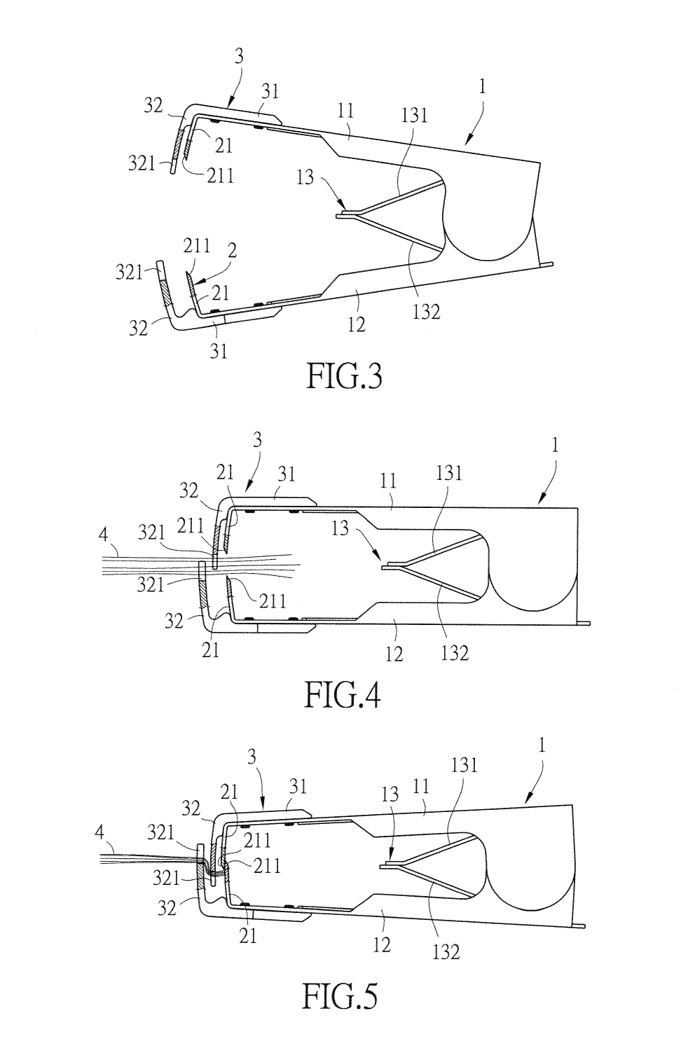

Referring to FIG. 4 and FIG. 5, it shows schematic views of a state of application of a first embodiment of the present invention. When the present invention is applied (also referring to FIGS. 1 and 3 at the same time), an end of the fixture 1, having the cutting unit 2 and combing unit 3, is correspondingly transfixed at a pre-determined position of hair 4 to be trimmed, allowing the hair 4 to fall into edges of the cutting unit 2 and combing unit 3. Then, external force is directly applied to the upper and lower tie plates 11, 12 of fixture 1, forcing the upper and lower tie plates 11, 12 to be abutted correspondingly and to compress the elastic element 13 simultaneously. At this time, each hair 4 will be trimmed by a mutual combination of the cutting part 21 of cutting unit 2 and the teeth part 32 of combing unit 3; whereas, the comb slots 321 of different depth on the teeth part 32 will fetch the hair 4 depending upon different length and thickness, followed by trimming the hair 4 in association with the notches 211 of different depth on the cutting part 21. Accordingly, a thinning and a cutting operation of multiple levels can be conducted by the combination of fixture 1, cutting unit 2 and combing unit 3 while trimming the hair 4, thereby enabling the hair 4 to achieve an effect of multi-edged thinning and a sense of style and beauty.

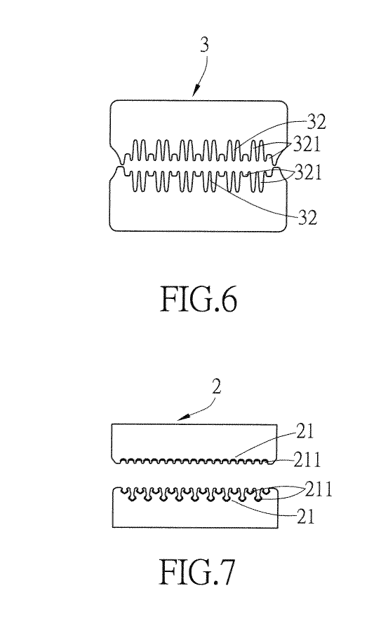

Referring to FIG. 6 and FIG. 7, it shows front views of a combing unit 3 and a cutting unit 2 of an embodiment of the present invention.

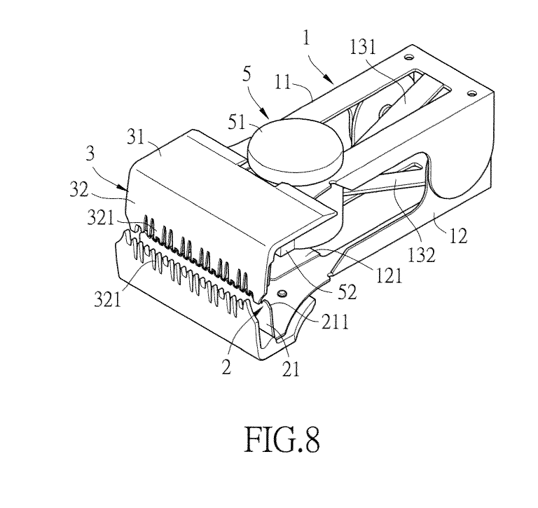

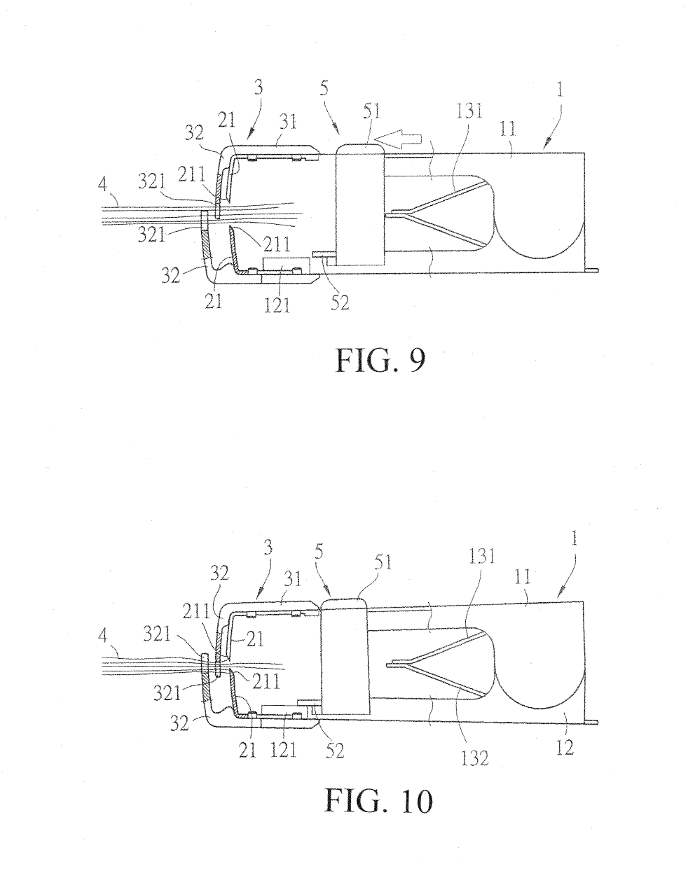

Referring to FIGS. 8 to 10, it shows a three-dimensional view, a schematic view of a complete trimming and a schematic view of a partial trimming, of a second embodiment of the present invention. In addition to the structures of aforementioned first embodiment, the fixture 1 is also loosely provided with a limiting unit 5, and an inner surface of the lower tie plate 12 is provided with a protruded part 121 which forms interference with the limiting unit 5; whereas, the limiting unit 5 includes at least a push bar 51 which is loosely provided between the upper and lower tie plates 11, 12, and a stop member 52 which is provided at a front end of the push bar 51 and can be moved forward to abut against the protruded part 121.

Upon operation, a position of the limiting unit 5 can be adjusted to select a partial trimming or a complete trimming. When the partial trimming is to be conducted, the push bar 51 of the limiting unit 5 is pushed forward, allowing a front end of the stop member 52 to be abutted upon an end surface of the protruded part 121 that the upper and lower tie plates 11, 12 can be only pressed to a pre-determined position, which limits a moving distance of the cutting part 21 of cutting unit 2 and the teeth part 32 of combing unit 3. In addition, when trimming, the comb slots 321 of different depth on the teeth part 32 is utilized to fetch a part of the hair, and then the part of hair is trimmed in association with the notches 211 of different depth on the cutting part 21.

On the other hand, if the push bar 51 of the limiting unit 5 is pushed backward in trimming, the stop member 52 will be free from the upper surface of the protruded part 121. At this time, the upper and lower tie plates 11, 12 will be completely abutted by compression of the external force, and the comb slots 321 of different depth on the teeth part 32 will fetch randomly the hair of various length, followed by conducting the complete trimming to the hair, in association with the notches 211 of different depth on the cutting part 21. Therefore, the present invention can better meet a practical need and function.

Accordingly, the hair trimmer of present invention can effectively improve all kinds of shortcomings of the prior art by utilizing the combination of fixture, cutting unit and combing unit to conduct the multi-edged thinning operation, allowing the hair trimming to be provided with more sense of style and beauty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A hair trimmer comprising a fixture which includes at least an upper and a lower tie plates, an end of which is pivoted together, with an elastic element being provided between the upper and lower tie plates, and a limiting unit being loosely provided on the fixture; at least two cutting units which are assembled respectively at an end of the upper and lower tie plates, with each cutting unit being provided respectively with a corresponding cutting part, and an end of each cutting part being provided respectively with a plurality of notches of different depth; and at least two combing units which are assembled respectively with the upper and lower tie plates and correspond to an exterior side of each cutting unit, with each combing unit including respectively a teeth part that corresponds to each other and is parallel to the cutting part, and an end of each teeth part being provided respectively with a plurality of comb slots of different depth.

2. The hair trimmer according to claim 1, wherein the elastic element of fixture is configured as spring leaves which are provided respectively at an inner surface of the upper and lower tie plates and are abutted with each other.

3. The hair trimmer according to claim 1, wherein an inner surface of the lower tie plate is provided with a protruded part which forms interference with the limiting unit, and the limiting unit includes at least a push bar which is loosely provided between the upper and lower tie plate, and a stop member which is provided at a front end of the push bar and is abutted with the protruded part.

4. The hair trimmer according to claim 1, wherein the teeth part of each combing unit is transversely provided with a fixing plate respectively, and each fixing plate is fixed respectively at an exterior surface of the upper and lower tie plate.
